(19) United States
(12) Patent Application Publication
(10) Pub. No.: US 2006/0259733 A1
(43) Pub. Date: Nov. 16, 2006

(54) Methods and apparatus for resource management in a logically partitioned processing environment

(75) Inventors: Takeshi Yamazaki, Yokohama (JP); Tsutomu Horikawa, Kanagawa (JP); Kenichi Murata, Tokyo (JP); Michael Norman Day, Round Rock, TX (US)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc., Minato-ku (JP)

(21) Appl. No.: 11/341,702

(22) Filed: Jan. 27, 2006

Related U.S. Application Data
(60) Provisional application No. 60/681,082, filed on May 13, 2005.

(51) Int. Cl. G06F 12/00

(52) U.S. Cl. 711/173

(57) ABSTRACT

Methods and apparatus provide for logically-partitioning respective processors of a multi-processing system into a plurality of resource groups; and time-allocating resources among the resource groups as a function of a predetermined algorithm.

### CROSS REFERENCE TO RELATED APPLICATION

This application claims the benefit of U.S. Provisional Patent Application No. 60/681,082, filed May 13, 2005, the entire disclosure of which is hereby incorporated by reference.

### BACKGROUND

The present invention relates to methods and apparatus for transferring data within a multi-processing system.

In recent years, there has been an insatiable desire for faster computer processing data throughputs because cutting-edge computer applications involve real-time, multimedia functionality. Graphics applications are among those that place the highest demands on a processing system because they require such vast numbers of data accesses, data computations, and data manipulations in relatively short periods of time to achieve desirable visual results. These applications require extremely fast processing speeds, such as many thousands of megabits of data per second. While some processing systems employ a single processor to achieve fast processing speeds, others are implemented utilizing multi-processor architectures. In multi-processor systems, a plurality of sub-processors can operate in parallel (or at least in concert) to achieve desired processing results.

Logical partitioning is a system architecture approach that allows a single processing system to be divided into several independent virtual systems (or logical partitions). In other words, the hardware resources of the processing system are virtualized such that that they can be shared by multiple independent operating environments. Thus, respective processors, a system memory, and I/O devices of the system may be logically separated such that independent operating systems may be run within each partition.

### SUMMARY OF THE INVENTION

Aspects of the present invention contemplate combining aspects of logical partitioning of a processing system with resource management, in terms of resource consumption. For example, the quantity of memory utilized by one or more partitions may be dynamically adjusted, the I/O bandwidth utilized by one or more partitions may be dynamically adjusted, and the cache replacement policy may be managed (and possibly adjusted) in accordance with the one or more partitions.

Each potential resource requester (e.g., the processors, the system memory, and the I/O devices) is assigned to a particular resource management group (RMG), where each group is defined by the logical partitioning arrangement. A system manager program is operable to receive resource requests from the RMGs, such as memory allocation requests, memory access bandwidth requests, I/O bandwidth requests, etc. The system manager program is also operable to assign such resources to the RMGs in response to the requests. Preferably the assignment is dynamic such that the assigned resources may be adjusted based on time-variant resource requests.

The system manager program is also preferably operable to assign cache line sets based on the logical partitioning of the system memory among the RMGs. In particular, aspects of the invention provide for a resource management table (RMT) that correlates effective address ranges of the system memory with groups of L2 cache line sets. The assignment of the L2 cache in this way avoids casting out time critical data (e.g., interrupt vectors) and prevents streaming data from replacing all other data in the cache.

In accordance with one or more embodiments of the present invention, methods and apparatus provide for: logically-partitioning respective processors of a multi-processing system into a plurality of resource groups; and time-allocating resources among the resource groups as a function of a predetermined algorithm. The resources may include at least one of: (i) portions of communication bandwidths between the processors and one or more input/output devices; (ii) portions of space within a shared memory used by the processors; and (iii) one or more sets of cache memory lines used by one or more of the processors.

The methods and apparatus may also provide for receiving requests for one or more resources from the resource groups and allocating some or all of the requested resources based upon whether such resources are available. Also provided may be at least one of: allocating some or all of the requested resources without exceeding a predetermined threshold; establishing potentially different thresholds for each resource group; and establishing potentially different thresholds for each resource. Preferably an aggregate of the thresholds for the same resource represents 100% of that resource.

The methods and apparatus may also provide for increasing a previously allocated portion of a resource for a given resource group toward the requested portion when one or more others of the resource groups request a lower amount of that resource.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the embodiments of the invention, there are shown in the drawings forms that are presently preferred, it being understood, however, that the embodiments of the invention are not limited to the precise arrangements and instrumentalities shown.

FIG. 1 is a block diagram of a multi-processor system in accordance with one or more aspects of the present invention;

FIG. 2 is a block diagram illustrating a preferred structure of a processor within the multi-processing system of FIG. 1 and/or other embodiments herein in accordance with one or more aspects of the present invention;

FIG. 3 is a graphical illustration of resource allocation among a plurality of partitions that may be carried out by one or more of the elements of FIG. 1 and/or other embodiments herein;

FIG. 4 is a partial block diagram and partial flow diagram illustrating a cache management resource allocation that may be employed by the system of FIG. 1 (and/or other embodiments herein);

FIG. 5 is a block diagram illustrating a preferred processor element (PE) that may be used to implement one or more further aspects of the present invention;

FIG. 6 is a diagram illustrating the structure of an exemplary sub-processing unit (SPU) of the system of FIG. 5 that may be adapted in accordance with one or more further aspects of the present invention; and

FIG. 7 is a diagram illustrating the structure of an exemplary processing unit (PU) of the system of FIG. 5 that may be adapted in accordance with one or more further aspects of the present invention.

### DETAILED DESCRIPTION OF THE PRESENT INVENTION

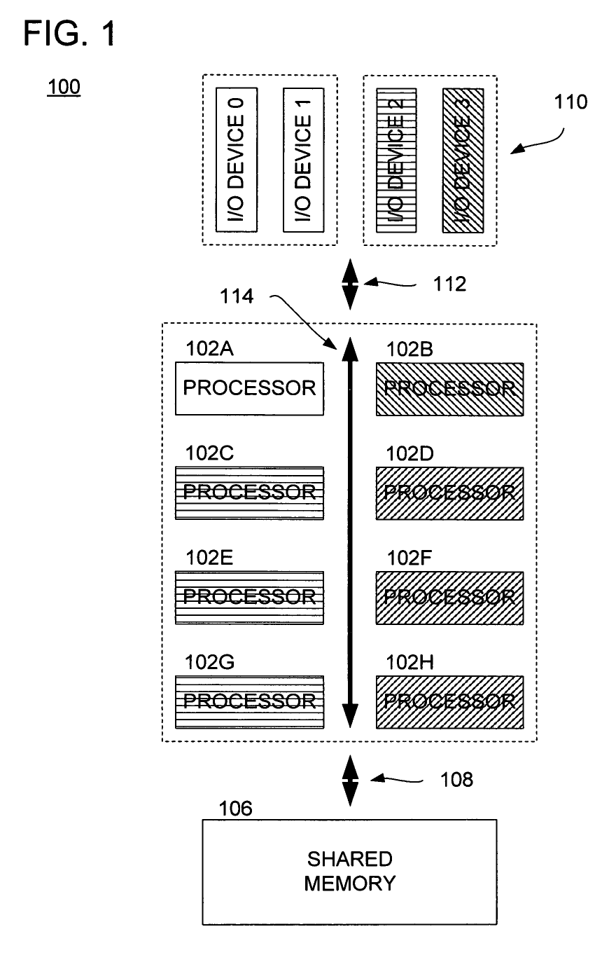

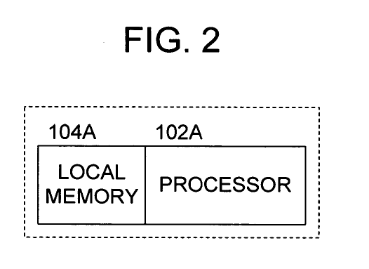

With reference to the drawings, wherein like numerals indicate like elements, there is shown in FIG. 1 a processing system 100 that may be adapted for carrying out one or more features of the present invention. For the purposes of brevity and clarity, the block diagrams of FIGS. 1-2 will be referred to and described herein as illustrating an apparatus, it being understood, however, that the description may readily be applied to various aspects of a method with equal force.

The processing system 100 is a multi-processing system that may be adapted to implement the features discussed herein and one or more further embodiments of the present invention. The system 100 includes a plurality of processors 102A-H, a shared memory 106 interconnected by way of a bus 108, and a plurality of input/output (I/O) devices 110 coupled to the processors over a bus 112. Data transfer fabric 114 permits data flow throughout the system. In this regard, the bus 108, the bus 112 and the transfer fabric 114 may all be considered part of the same data transfer circuitry. The shared memory 106 may also be referred to herein as a main memory or system memory.

Although eight processors 102 are illustrated by way of example, any number may be utilized without departing from the spirit and scope of the present invention. Each of the processors 102 may be of similar construction or of differing construction. The processors 102 may be implemented utilizing any of the known technologies that are capable of requesting data from the system memory 106, and manipulating the data to achieve a desirable result. For example, the processors 102 may be implemented using any of the known microprocessors that are capable of executing software and/or firmware, including standard microprocessors, distributed microprocessors, etc. By way of example, one or more of the processors 102 may be a graphics processor that is capable of requesting and manipulating data, such as pixel data, including gray scale information, color information, texture data, polygonal information, video frame information, etc.

With reference to FIG. 2, each processor 102 preferably includes a local memory 104 associated therewith. The local memories 104 are preferably located on the same chip (same semiconductor substrate) as their respective processors 102; however, the local memories 104 are preferably not traditional hardware cache memories in that there are no on-chip or off-chip hardware cache circuits, cache registers, cache memory controllers, etc. to implement a hardware cache memory function. As on-chip space may be limited, the size of the local memories 104 may be much smaller than the system memory 106.

The processors 102 preferably provide data access requests to copy data (which may include program data) from the system memory 106 over the bus 108 into their respective local memories 104 for program execution and data manipulation. The mechanism for facilitating data access is preferably implemented utilizing a direct memory access controller (DMAC), not shown, which may be disposed internally or externally with respect to the processors 102.

Each processor 102 is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processors 102 may include an instruction buffer, instruction decode circuitry, dependency check circuitry, instruction issue circuitry, and execution stages.

The system memory 106 is preferably a dynamic random access memory (DRAM) coupled to the processors 102 through a high bandwidth memory connection (not shown). Although the system memory 106 is preferably a DRAM, the memory 106 may be implemented using other means, e.g., a static random access memory (SRAM), a magnetic random access memory (MRAM), an optical memory, a holographic memory, etc.

In one or more embodiments, the processors 102 and the local memories 104 may be disposed on a common semiconductor substrate. In one or more further embodiments, the shared memory 106 may also be disposed on the common semiconductor substrate or it may be separately disposed.

The I/O devices 110 preferably provide a high-performance interconnection between the multi-processing system 100 and other, external systems, such as other processing systems, networks, peripheral devices, memory subsystems, switches, bridge chips, etc. The I/O devices 110 preferably provide either coherent or non-coherent communications and interfaces with proper protocols and bandwidth capabilities to address differing system requirements.

In accordance with one or more embodiments of the present invention, the multi-processing system 100 also preferably includes a resource management unit that is operable to allocate resources of the system to the respective processors 102 as a function of time. More particularly, the processors 102 are preferably partitioned (on a logical basis) into a plurality of resource groups and the resource management unit allocates the resources among such groups. While the specifics of the resources may vary depending on system details, examples of such resources include at least one of: (i) portions of communication bandwidths between the processors 102 and the I/O devices 110; and (ii) portions of space within the shared memory 106.

In one or more alternative embodiments, one or more of the processors 102 may operate as the resource management unit. In this regard, such processor 102 acts as a main processor operatively coupled to the other processors 102 and capable of being coupled to the shared memory 106 over the bus 108. (It is noted that the main processor may also be involved in other tasks, besides resource management, scheduling and/or orchestrating the processing of data by the other processors 102.)

Although not specifically directed to the resource management function, the main processor 102 may be coupled to a hardware cache memory, which is operable cache data obtained from at least one of the shared memory 106 and one or more of the local memories 104 of the processors 102. The main processor may provide data access requests to copy data (which may include program data) from the system memory 106 over the bus 108 into the cache memory for program execution and data manipulation utilizing any of the known techniques, such as DMA techniques.

By way of example, processor 102A may be logically partitioned into a first resource group, processors 102D, 102F and 102H may be part of a second resource group, processor 102B may be part of a third resource group, and processors 102C, 102E, and 102G may be part of a fourth resource group. Delineation of resource groups is shown by similar cross-hatching. Preferably, the resource management unit is operable to receive requests for resources from the plurality of processors 102, where each request is for one or more resources, such as the communication bandwidths, the space within the shared memory 106, etc. In response, the resource management unit is preferably operable to allocate some or all of the requested resources based upon whether such resources are available.

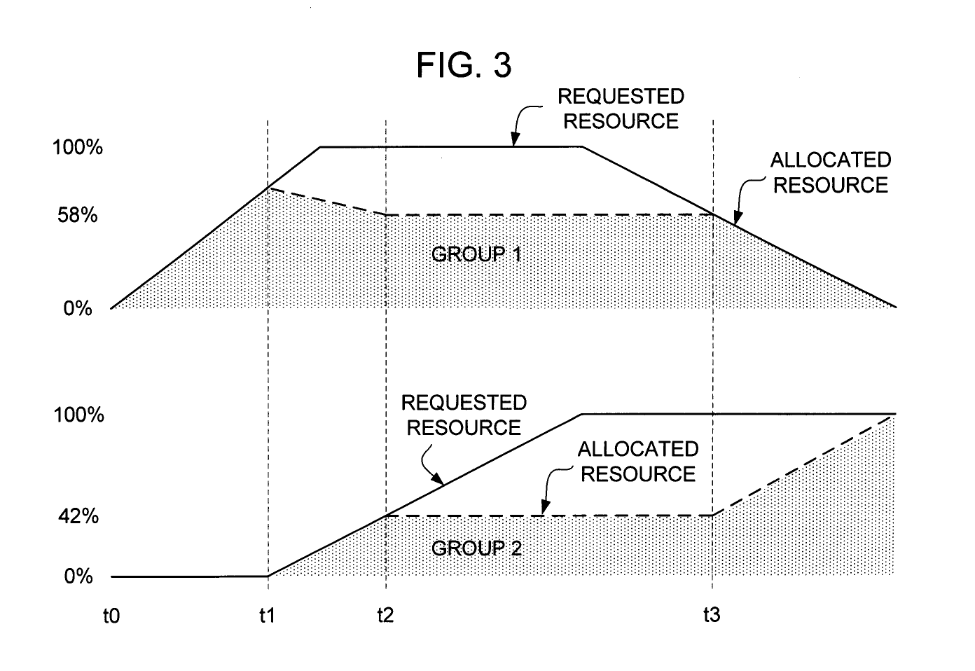

By way of example, FIG. 3 is a graph illustrating profiles of requested resources verses time in connection with two resource groups, such as group 1 and 3 above. For the purposes of illustration, it is assumed that the requested resources are portions of the communication bandwidth between the processors 102 and the I/O devices 110. At time t0, neither group 1 or 3 are requesting bandwidth. Between t0 and t1, group 1 increases its requests for bandwidth, e.g., by one or more processors therein issuing one or more requests for resources to the resource management unit. At time t1, group 3 (e.g., processor 102B) also begins to request bandwidth by issuing one or more requests for resources to the resource management unit. Thus, between time t1 and t2, the portion of bandwidth allocated to group 1 diminishes somewhat, while the amount of bandwidth allocated to group 3 increases.

Preferably, the resource management unit is operable to allocate some or all of the requested resources to the resource groups (and respective processors) without exceeding a predetermined threshold associated with each processor or group. In this example, the threshold associated with group 1 represents about 58% of the total available bandwidth, while the threshold associated with group 3 represents 42% of the total available bandwidth. In this regard, the aggregate of the thresholds is representative of 100% of the total available resource, in this case the bandwidth to the I/O devices 110. Thus, the resource management unit allocates the requested resources to the resource groups to the extent that the requested resources to do not exceed the respective thresholds for each processor or group.

At time t3 the requested bandwidth by group 1 falls below the assigned threshold for that group. In this regard, the resource management unit is preferably operable to increase the previously allocated amount of bandwidth for group 3 (e.g., the processor 102B) toward the requested amount (e.g., 100% in this example) when group 1 requests a lower amount of the bandwidth.

Those skilled in the art will appreciate that the resource allocation among the resource groups as illustrated in FIG. 3 represents but one of many different profiles that may be carried out by one or more of the embodiments of the invention described herein.

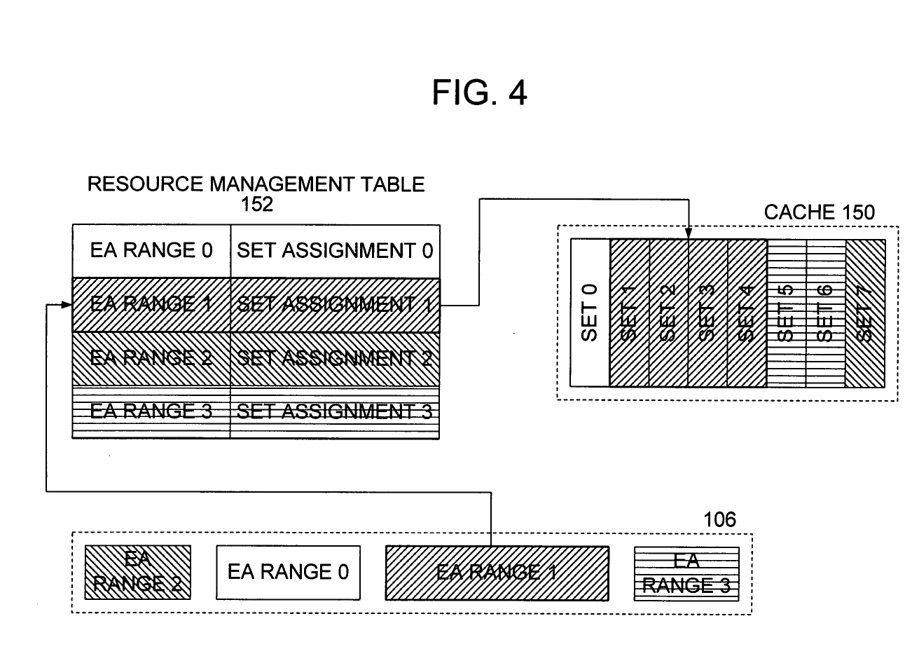

With reference to FIG. 4, respective portions of the shared memory 106 may be allocated by the resource management unit among the processors 102 of the resource groups. As in the previous example relating to allocation of bandwidth to the I/O devices 110, the resource groups (e.g., the processors thereof) may request portions of the shared memory 106 for allocation by the resource management unit as a function of time. Thus, the discussion hereinabove with respect to FIG. 3 may be extended to the allocation of space within the shared memory 106 among the processors 102.

Using the profile of FIG. 3 again for the purposes of an example, at time t0, neither group 1 or 3 are requesting space within the shared memory 106. Between t0 and t1, group 1 increases its requests for memory, e.g., by one or more processors therein issuing one or more requests for resources to the resource management unit. At time t1, group 3 request memory space by issuing one or more requests for resources to the resource management unit. Thus, between time t1 and t2, the portion of shared memory 106 allocated to group 1 diminishes, while the amount of memory allocated to group 3 increases. Again, the threshold associated with group 1 represents about 58% of the total available memory, while the threshold associated with group 3 represents 42% of the total available memory. At time t3 the requested memory space within the shared memory 106 by group 1 falls below the assigned threshold for that group. In this regard, the resource management unit is preferably operable to increase the previously allocated amount of memory for group 3 (e.g., the processor 102B) toward the requested amount (e.g., 100% in this example) when group 1 requests a lower amount of the memory.

Turning again to FIG. 4, and in accordance with one or more further embodiments of the present invention, the resources of the system may also include respective sets (cache lines) of the cache memory that may be allocated. In this regard, the resource management unit is preferably operable to associate respective ranges of the shared memory 106 with respective sets of the cash memory 150 and dynamically changing such association as a function of time. Preferably, the resource management unit maintains and/or has access to a resource management table 152, which associates respective ranges of the shared memory 106 with the respective sets of the cash memory 150. For example, an effective address (EA) range 0 of the shared memory 106 may be associated with a set 0 of the cash memory 150, an EA range 1 of the shared memory 106 may be associated with sets 1-4 of the cash memory 150, an EA range 2 of the shared memory 106 may be associated with set 7 of the cash memory 150, and an EA range 3 of the shared memory 106 may be associated with sets 5-6 of the cash memory 150. These set assignments may be changed dynamically by the resource management unit in response to requests by the resource groups. Such assignments and changes thereto may also be characterized in a similar way as discussed hereinabove with respect to FIG. 3 with the exception that the resources at issue are the cash lines of the cash memory 150.

Using the profile of FIG. 3 again for the purposes of an example, at time t0, neither group 1 or 3 are requesting cache lines (sets) within the cache memory. Between t0 and t1, group 1 increases its requests for cache resources, e.g., by one or more processors therein issuing one or more requests for resources to the resource management unit. At time t1, group 3 request cache space by issuing one or more requests for resources to the resource management unit. Thus, between time t1 and t2, the portion of the cache memory allocated to group 1 diminishes, while the amount of cache memory allocated to group 3 increases. Again, the threshold associated with group 1 represents about 58% of the total available cache sets, while the threshold associated with group 3 represents 42% of the total available cache. At time t3 the requested cache allocation by group 1 falls below the assigned threshold for that group. In this regard, the resource management unit is preferably operable to increase the previously allocated amount of cache resource for group 3 toward the requested amount (e.g., 100% in this example) when group 1 requests a lower amount of cache allocation.

A description of a preferred computer architecture for a multi-processor system will now be provided that is suitable for carrying out one or more of the features discussed herein. In accordance with one or more embodiments, the multi-processor system may be implemented as a single-chip solution operable for stand-alone and/or distributed processing of media-rich applications, such as game systems, home terminals, PC systems, server systems and workstations. In some applications, such as game systems and home terminals, real-time computing may be a necessity. For example, in a real-time, distributed gaming application, one or more of networking image decompression, 3D computer graphics, audio generation, network communications, physical simulation, and artificial intelligence processes have to be executed quickly enough to provide the user with the illusion of a real-time experience. Thus, each processor in the multi-processor system must complete tasks in a short and predictable time.

To this end, and in accordance with this computer architecture, all processors of a multi-processing computer system are constructed from a common computing module (or cell). This common computing module has a consistent structure and preferably employs the same instruction set architecture. The multi-processing computer system can be formed of one or more clients, servers, PCs, mobile computers, game machines, PDAs, set top boxes, appliances, digital televisions and other devices using computer processors.

A plurality of the computer systems may also be members of a network if desired. The consistent modular structure enables efficient, high speed processing of applications and data by the multi-processing computer system, and if a network is employed, the rapid transmission of applications and data over the network. This structure also simplifies the building of members of the network of various sizes and processing power and the preparation of applications for processing by these members.

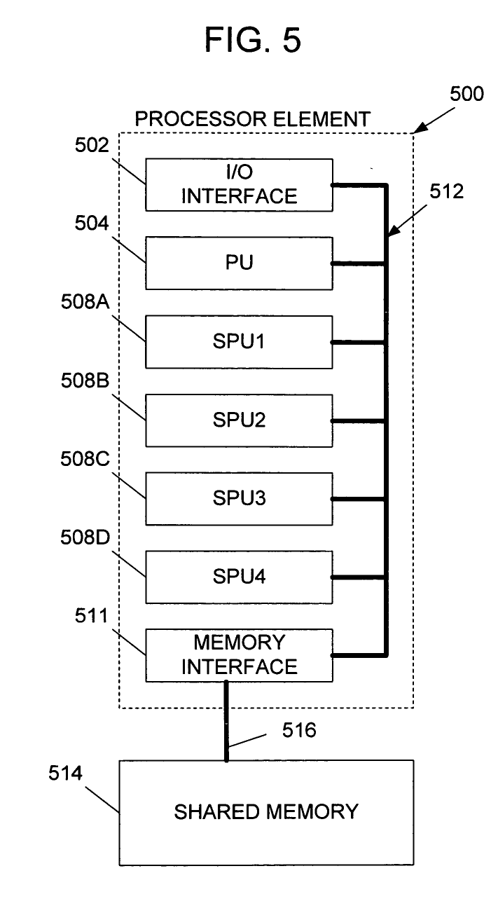

With reference to FIG. 5, the basic processing module is a processor element (PE) 500. The PE 500 comprises an I/O interface 502, a processing unit (PU) 504, and a plurality of sub-processing units 508, namely, sub-processing unit 508A, sub-processing unit 508B, sub-processing unit 508C, and sub-processing unit 508D. A local (or internal) PE bus 512 transmits data and applications among the PU 504, the sub-processing units 508, and a memory interface 511. The local PE bus 512 can have, e.g., a conventional architecture or can be implemented as a packet-switched network. If implemented as a packet switch network, while requiring more hardware, increases the available bandwidth.

The PE 500 can be constructed using various methods for implementing digital logic. The PE 500 preferably is constructed, however, as a single integrated circuit employing a complementary metal oxide semiconductor (CMOS) on a silicon substrate. Alternative materials for substrates include gallium arsinide, gallium aluminum arsinide and other so-called III-B compounds employing a wide variety of dopants. The PE 500 also may be implemented using superconducting material, e.g., rapid single-flux-quantum (RSFQ) logic.

The PE 500 is closely associated with a shared (main) memory 514 through a high bandwidth memory connection 516. Although the memory 514 preferably is a dynamic random access memory (DRAM), the memory 514 could be implemented using other means, e.g., as a static random access memory (SRAM), a magnetic random access memory (MRAM), an optical memory, a holographic memory, etc.

The PU 504 and the sub-processing units 508 are preferably each coupled to a memory flow controller (MFC) including direct memory access DMA functionality, which in combination with the memory interface 511, facilitate the transfer of data between the DRAM 514 and the sub-processing units 508 and the PU 504 of the PE 500. It is noted that the DMAC and/or the memory interface 511 may be integrally or separately disposed with respect to the sub-processing units 508 and the PU 504. Indeed, the DMAC function and/or the memory interface 511 function may be integral with one or more (preferably all) of the sub-processing units 508 and the PU 504. It is also noted that the DRAM 514 may be integrally or separately disposed with respect to the PE 500. For example, the DRAM 514 may be disposed off-chip as is implied by the illustration shown or the DRAM 514 may be disposed on-chip in an integrated fashion.

The PU 504 can be, e.g., a standard processor capable of stand-alone processing of data and applications. In operation, the PU 504 preferably schedules and orchestrates the processing of data and applications by the sub-processing units. The sub-processing units preferably are single instruction, multiple data (SIMD) processors. Under the control of the PU 504, the sub-processing units perform the processing of these data and applications in a parallel and independent manner. The PU 504 is preferably implemented using a PowerPC core, which is a microprocessor architecture that employs reduced instruction-set computing (RISC) technique. RISC performs more complex instructions using combinations of simple instructions. Thus, the timing for the processor may be based on simpler and faster operations, enabling the microprocessor to perform more instructions for a given clock speed.

It is noted that the PU 504 may be implemented by one of the sub-processing units 508 taking on the role of a main processing unit that schedules and orchestrates the processing of data and applications by the sub-processing units 508. Further, there may be more than one PU implemented within the processor element 500.

In accordance with this modular structure, the number of PEs 500 employed by a particular computer system is based upon the processing power required by that system. For example, a server may employ four PEs 500, a workstation may employ two PEs 500 and a PDA may employ one PE 500. The number of sub-processing units of a PE 500 assigned to processing a particular software cell depends upon the complexity and magnitude of the programs and data within the cell.

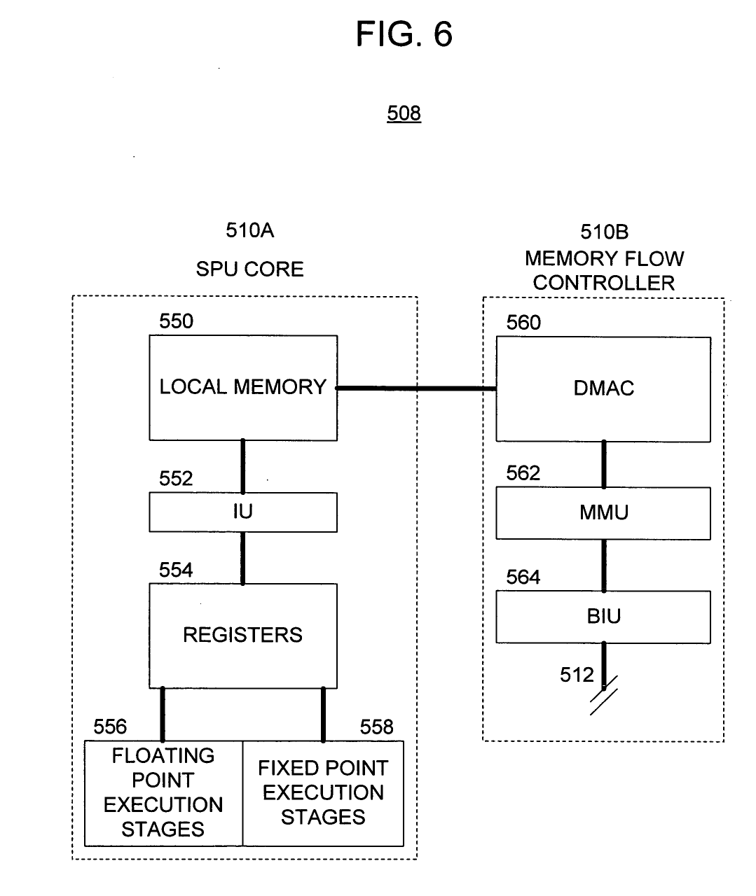

FIG. 6 illustrates the preferred structure and function of a sub-processing unit (SPU) 508. The SPU 508 architecture preferably fills a void between general-purpose processors (which are designed to achieve high average performance on a broad set of applications) and special-purpose processors (which are designed to achieve high performance on a single application). The SPU 508 is designed to achieve high performance on game applications, media applications, broadband systems, etc., and to provide a high degree of control to programmers of real-time applications. Some capabilities of the SPU 508 include graphics geometry pipelines, surface subdivision, Fast Fourier Transforms, image processing keywords, stream processing, MPEG encoding/decoding, encryption, decryption, device driver extensions, modeling, game physics, content creation, and audio synthesis and processing.

The sub-processing unit 508 includes two basic functional units, namely an SPU core 510A and a memory flow controller (MFC) 510B. The SPU core 510A performs program execution, data manipulation, etc., while the MFC 510B performs functions related to data transfers between the SPU core 510A and the DRAM 514 of the system.

The SPU core 510A includes a local memory 550, an instruction unit (IU) 552, registers 554, one ore more floating point execution stages 556 and one or more fixed point execution stages 558. The local memory 550 is preferably implemented using single-ported random access memory, such as an SRAM. Whereas most processors reduce latency to memory by employing caches, the SPU core 510A implements the relatively small local memory 550 rather than a cache. Indeed, in order to provide consistent and predictable memory access latency for programmers of real-time applications (and other applications as mentioned herein) a cache memory architecture within the SPU 508A is not preferred. The cache hit/miss characteristics of a cache memory results in volatile memory access times, varying from a few cycles to a few hundred cycles. Such volatility undercuts the access timing predictability that is desirable in, for example, real-time application programming. Latency hiding may be achieved in the local memory SRAM 550 by overlapping DMA transfers with data computation. This provides a high degree of control for the programming of real-time applications. As the latency and instruction overhead associated with DMA transfers exceeds that of the latency of servicing a cache miss, the SRAM local memory approach achieves an advantage when the DMA transfer size is sufficiently large and is sufficiently predictable (e.g., a DMA command can be issued before data is needed).

A program running on a given one of the sub-processing units 508 references the associated local memory 550 using a local address, however, each location of the local memory 550 is also assigned a real address (RA) within the overall system's memory map. This allows Privilege Software to map a local memory 550 into the Effective Address (EA) of a process to facilitate DMA transfers between one local memory 550 and another local memory 550. The PU 504 can also directly access the local memory 550 using an effective address. In a preferred embodiment, the local memory 550 contains 556 kilobytes of storage, and the capacity of registers 552 is 128×128 bits.

The SPU core 504A is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the IU 552 includes an instruction buffer, instruction decode circuitry, dependency check circuitry, and instruction issue circuitry.

The instruction buffer preferably includes a plurality of registers that are coupled to the local memory 550 and operable to temporarily store instructions as they are fetched. The instruction buffer preferably operates such that all the instructions leave the registers as a group, i.e., substantially simultaneously. Although the instruction buffer may be of any size, it is preferred that it is of a size not larger than about two or three registers.

In general, the decode circuitry breaks down the instructions and generates logical micro-operations that perform the function of the corresponding instruction. For example, the logical micro-operations may specify arithmetic and logical operations, load and store operations to the local memory 550, register source operands and/or immediate data operands. The decode circuitry may also indicate which resources the instruction uses, such as target register addresses, structural resources, function units and/or busses. The decode circuitry may also supply information indicating the instruction pipeline stages in which the resources are required. The instruction decode circuitry is preferably operable to substantially simultaneously decode a number of instructions equal to the number of registers of the instruction buffer.

The dependency check circuitry includes digital logic that performs testing to determine whether the operands of given instruction are dependent on the operands of other instructions in the pipeline. If so, then the given instruction should not be executed until such other operands are updated (e.g., by permitting the other instructions to complete execution). It is preferred that the dependency check circuitry determines dependencies of multiple instructions dispatched from the decoder circuitry 112 simultaneously.

The instruction issue circuitry is operable to issue the instructions to the floating point execution stages 556 and/or the fixed point execution stages 558.

The registers 554 are preferably implemented as a relatively large unified register file, such as a 128-entry register file. This allows for deeply pipelined high-frequency implementations without requiring register renaming to avoid register starvation. Renaming hardware typically consumes a significant fraction of the area and power in a processing system. Consequently, advantageous operation may be achieved when latencies are covered by software loop unrolling or other interleaving techniques.

Preferably, the SPU core 510A is of a superscalar architecture, such that more than one instruction is issued per clock cycle. The SPU core 510A preferably operates as a superscalar to a degree corresponding to the number of simultaneous instruction dispatches from the instruction buffer, such as between 2 and 3 (meaning that two or three instructions are issued each clock cycle). Depending upon the required processing power, a greater or lesser number of floating point execution stages 556 and fixed point execution stages 558 may be employed. In a preferred embodiment, the floating point execution stages 556 operate at a speed of 32 billion floating point operations per second (32 GFLOPS), and the fixed point execution stages 558 operate at a speed of 32 billion operations per second (32 GOPS).

The MFC 510B preferably includes a bus interface unit (BIU) 564, a memory management unit (MMU) 562, and a direct memory access controller (DMAC) 560. With the exception of the DMAC 560, the MFC 510B preferably runs at half frequency (half speed) as compared with the SPU core 510A and the bus 512 to meet low power dissipation design objectives. The MFC 510B is operable to handle data and instructions coming into the SPU 508 from the bus 512, provides address translation for the DMAC, and snoop-operations for data coherency. The BIU 564 provides an interface between the bus 512 and the MMU 562 and DMAC 560. Thus, the SPU 508 (including the SPU core 510A and the MFC 510B) and the DMAC 560 are connected physically and/or logically to the bus 512.

The MMU 562 is preferably operable to translate effective addresses (taken from DMA commands) into real addresses for memory access. For example, the MMU 562 may translate the higher order bits of the effective address into real address bits. The lower-order address bits, however, are preferably untranslatable and are considered both logical and physical for use to form the real address and request access to memory. In one or more embodiments, the MMU 562 may be implemented based on a 64-bit memory management model, and may provide 2⁶⁴ bytes of effective address space with 4K-, 64K-, 1M-, and 16M-byte page sizes and 256 MB segment sizes. Preferably, the MMU 562 is operable to support up to 265 bytes of virtual memory, and 242 bytes (4 TeraBytes) of physical memory for DMA commands. The hardware of the MMU 562 may include an 8-entry, fully associative SLB, a 256-entry, 4way set associative TLB, and a 4×4 Replacement Management Table (RMT) for the TLB—used for hardware TLB miss handling.

The DMAC 560 is preferably operable to manage DMA commands from the SPU core 510A and one or more other devices such as the PU 504 and/or the other SPUs. There may be three categories of DMA commands: Put commands, which operate to move data from the local memory 550 to the shared memory 514; Get commands, which operate to move data into the local memory 550 from the shared memory 514; and Storage Control commands, which include SLI commands and synchronization commands. The synchronization commands may include atomic commands, send signal commands, and dedicated barrier commands. In response to DMA commands, the MMU 562 translates the effective address into a real address and the real address is forwarded to the BIU 564.

The SPU core 510A preferably uses a channel interface and data interface to communicate (send DMA commands, status, etc.) with an interface within the DMAC 560. The SPU core 510A dispatches DMA commands through the channel interface to a DMA queue in the DMAC 560. Once a DMA command is in the DMA queue, it is handled by issue and completion logic within the DMAC 560. When all bus transactions for a DMA command are finished, a completion signal is sent back to the SPU core 510A over the channel interface.

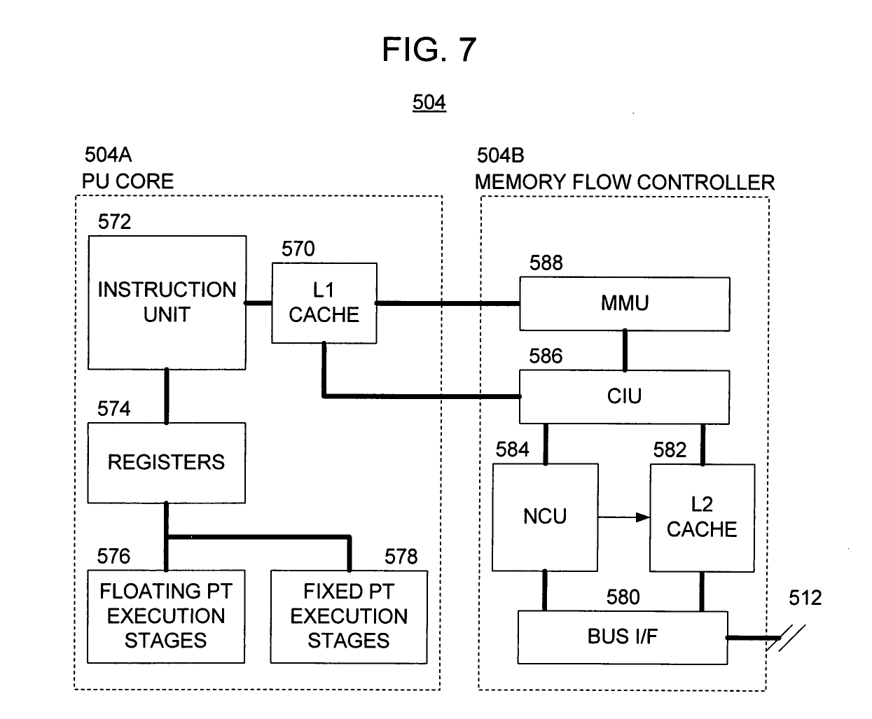

FIG. 7 illustrates the preferred structure and function of the PU 504. The PU 504 includes two basic functional units, the PU core 504A and the memory flow controller (MFC) 504B. The PU core 504A performs program execution, data manipulation, multi-processor management functions, etc., while the MFC 504B performs functions related to data transfers between the PU core 504A and the memory space of the system 100.

The PU core 504A may include an L1 cache 570, an instruction unit 572, registers 574, one or more floating point execution stages 576 and one or more fixed point execution stages 578. The L1 cache provides data caching functionality for data received from the shared memory 106, the processors 102, or other portions of the memory space through the MFC 504B. As the PU core 504A is preferably implemented as a superpipeline, the instruction unit 572 is preferably implemented as an instruction pipeline with many stages, including fetching, decoding, dependency checking, issuing, etc. The PU core 504A is also preferably of a superscalar configuration, whereby more than one instruction is issued from the instruction unit 572 per clock cycle. To achieve a high processing power, the floating point execution stages 576 and the fixed point execution stages 578 include a plurality of stages in a pipeline configuration. Depending upon the required processing power, a greater or lesser number of floating point execution stages 576 and fixed point execution stages 578 may be employed.

The MFC 504B includes a bus interface unit (BIU) 580, an L2 cache memory, a non-cachable unit (NCU) 584, a core interface unit (CIU) 586, and a memory management unit (MMU) 588. Most of the MFC 504B runs at half frequency (half speed) as compared with the PU core 504A and the bus 108 to meet low power dissipation design objectives.

The BIU 580 provides an interface between the bus 108 and the L2 cache 582 and NCU 584 logic blocks. To this end, the BIU 580 may act as a Master as well as a Slave device on the bus 108 in order to perform fully coherent memory operations. As a Master device it may source load/store requests to the bus 108 for service on behalf of the L2 cache 582 and the NCU 584. The BIU 580 may also implement a flow control mechanism for commands which limits the total number of commands that can be sent to the bus 108. The data operations on the bus 108 may be designed to take eight beats and, therefore, the BIU 580 is preferably designed around 128 byte cache-lines and the coherency and synchronization granularity is 128 KB.

The L2 cache memory 582 (and supporting hardware logic) is preferably designed to cache 512 KB of data. For example, the L2 cache 582 may handle cacheable loads/stores, data pre-fetches, instruction fetches, instruction pre-fetches, cache operations, and barrier operations. The L2 cache 582 is preferably an 8-way set associative system. The L2 cache 582 may include six reload queues matching six (6) castout queues (e.g., six RC machines), and eight (64-byte wide) store queues. The L2 cache 582 may operate to provide a backup copy of some or all of the data in the L1 cache 570. Advantageously, this is useful in restoring state(s) when processing nodes are hot-swapped. This configuration also permits the L1 cache 570 to operate more quickly with fewer ports, and permits faster cache-to-cache transfers (because the requests may stop at the L2 cache 582). This configuration also provides a mechanism for passing cache coherency management to the L2 cache memory 582.

The NCU 584 interfaces with the CIU 586, the L2 cache memory 582, and the BIU 580 and generally functions as a queueing/buffering circuit for non-cacheable operations between the PU core 504A and the memory system. The NCU 584 preferably handles all communications with the PU core 504A that are not handled by the L2 cache 582, such as cache-inhibited load/stores, barrier operations, and cache coherency operations. The NCU 584 is preferably run at half speed to meet the aforementioned power dissipation objectives.

The CIU 586 is disposed on the boundary of the MFC 504B and the PU core 504A and acts as a routing, arbitration, and flow control point for requests coming from the execution stages 576, 578, the instruction unit 572, and the MMU unit 588 and going to the L2 cache 582 and the NCU 584. The PU core 504A and the MMU 588 preferably run at full speed, while the L2 cache 582 and the NCU 584 are operable for a 2:1 speed ratio. Thus, a frequency boundary exists in the CIU 586 and one of its functions is to properly handle the frequency crossing as it forwards requests and reloads data between the two frequency domains.

The CIU 586 is comprised of three functional blocks: a load unit, a store unit, and reload unit. In addition, a data pre-fetch function is performed by the CIU 586 and is preferably a functional part of the load unit. The CIU 586 is preferably operable to: (i) accept load and store requests from the PU core 504A and the MMU 588; (ii) convert the requests from full speed clock frequency to half speed (a 2:1 clock frequency conversion); (iii) route cachable requests to the L2 cache 582, and route non-cachable requests to the NCU 584; (iv) arbitrate fairly between the requests to the L2 cache 582 and the NCU 584; (v) provide flow control over the dispatch to the L2 cache 582 and the NCU 584 so that the requests are received in a target window and overflow is avoided; (vi) accept load return data and route it to the execution stages 576, 578, the instruction unit 572, or the MMU 588; (vii) pass snoop requests to the execution stages 576, 578, the instruction unit 572, or the MMU 588; and (viii) convert load return data and snoop traffic from half speed to full speed.

The MMU 588 preferably provides address translation for the PU core 540A, such as by way of a second level address translation facility. A first level of translation is preferably provided in the PU core 504A by separate instruction and data ERAT (effective to real address translation) arrays that may be much smaller and faster than the MMU 588.

In a preferred embodiment, the PU 504 operates at 4-6 GHz, 10F04, with a 64-bit implementation. The registers are preferably 64 bits long (although one or more special purpose registers may be smaller) and effective addresses are 64 bits long. The instruction unit 570, registers 572 and execution stages 574 and 576 are preferably implemented using PowerPC technology to achieve the (RISC) computing technique.

Additional details regarding the modular structure of this computer system may be found in U.S. Pat. No. 6,526,491, the entire disclosure of which is hereby incorporated by reference.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method, comprising:
logically-partitioning respective processors of a multi-processing system into a plurality of resource groups; and
time-allocating resources among the resource groups as a function of a predetermined algorithm.

2. The method of claim 1, wherein the resources include at least one of: (i) portions of communication bandwidths between the processors and one or more input/output devices; (ii) portions of space within a shared memory used by the processors; and (iii) one or more sets of cache memory lines used by one or more of the processors.

3. The method of claim 2, wherein the cache memory lines are used only by a managing processor.

4. The method of claim 1, further comprising:
receiving a request for one or more resources from a given processor; and
allocating some or all of the requested resources based upon whether such resources are available.

5. The method of claim 4, further comprising: allocating some or all of the requested resources without exceeding a predetermined threshold.

6. The method of claim 5, wherein:
the processors share a communication bandwidth to one or more input/output devices in order to send from, and receive data into, the multi-processing system;
the algorithm establishes one or more threshold portions of the bandwidth that may be allocated to each resource group; and
the step of allocating includes allocating a requested bandwidth to a given resource group to the extent that such requested bandwidth does not exceed the one or more thresholds.

7. The method of claim 6, further comprising establishing potentially different thresholds for each resource group.

8. The method of claim 6, wherein an aggregate of the thresholds represents 100% of available bandwidth to the input/output devices.

9. The method of claim 6, wherein the step of allocating includes increasing a previously allocated amount of bandwidth for a given resource group toward the requested amount when one or more others of the resource groups request a lower amount of the bandwidth.

10. The method of claim 5, wherein:
the processors are coupled to a shared memory for data storage in the multi-processing system;
the algorithm establishes one or more threshold portions of the shared memory that may be allocated to each resource group; and
the step of allocating includes allocating a requested portion of the shared memory to a given resource group to the extent that such requested portion does not exceed the one or more thresholds.

11. The method of claim 10, further comprising establishing potentially different thresholds for each resource group.

12. The method of claim 10, wherein an aggregate of the thresholds represents 100% of available shared memory space to the processors.

13. The method of claim 10, wherein the step of allocating includes increasing a previously allocated portion of the shared memory for a given resource group toward the requested portion when one or more others of the resource groups request a lower portion of the shared memory.

14. The method of claim 1, further comprising:
associating respective ranges of a shared memory of the multi-processing system with respective sets of cache memory lines, the sets being the resources; and
dynamically changing the association of the ranges with the sets as a function of the predetermined algorithm.

15. An apparatus, comprising:
a plurality of processors capable of operative communication with a shared memory, the processors being logically-partitioned into a plurality of resource groups; and
a resource managing unit operable to time-allocate resources among the resource groups as a function of a predetermined algorithm.

16. The apparatus of claim 15, wherein the resource managing unit is implemented by one of the processors.

17. The apparatus claim 15, wherein the resources include at least one of: (i) portions of communication bandwidths between the processors and one or more input/output devices of the multi-processor system; (ii) portions of space within the shared memory used by the processors; and (iii) one or more sets of cache memory lines used by one or more of the processors.

18. The apparatus of claim 17, wherein the cache memory lines are used only by a managing processor.

19. The apparatus of claim 15, wherein the resource management unit is operable to receive a request for one or more resources from the resource groups and allocate some or all of the requested resources based upon whether such resources are available.

20. The apparatus of claim 19, wherein at least one of:
the resource management unit is operable to allocate some or all of the requested resources without exceeding a predetermined threshold;
the resource management unit is operable to establish potentially different thresholds for each resource group;
the resource management unit is operable to establish potentially different thresholds for each resource; and
an aggregate of the thresholds for the same resource represents 100% of that resource.

21. The method of claim 20, wherein the resource management unit is operable to increase a previously allocated portion of a resource for a given processor toward the requested portion when one or more others of the processors request a lower amount of that resource.

22. The apparatus of claim 15, further comprising a local memory coupled to each processor, the local memories not being hardware cache memories and each processor being capable of executing programs within its local memory, but each processor is not being capable of executing programs within the shared memory.

23. The apparatus of claim 22, wherein at least one of:
the processors and associated local memories are disposed on a common semiconductor substrate; and
processors, associated local memories, and the shared memory are disposed on a common semiconductor substrate.

24. A storage medium containing an executable program, the executable program being operable to cause a multi-processing system to execute actions including:
logically-partitioning respective processors of a multi-processing system into a plurality of resource groups; and
time-allocating resources among the resource groups as a function of a predetermined algorithm.

25. The storage medium of claim 24, wherein the resources include at least one of: (i) portions of communication bandwidths between the processors and one or more input/output devices; (ii) portions of space within a shared memory used by the processors; and (iii) one or more sets of cache memory lines used by one or more of the processors.

26. The storage medium of claim 24, further comprising receiving requests for one or more resources from the resource groups and allocating some or all of the requested resources based upon whether such resources are available.

27. The storage medium of claim 26, further comprising at least one of:
allocating some or all of the requested resources without exceeding a predetermined threshold;
establishing potentially different thresholds for each resource group; and
establishing potentially different thresholds for each resource,
wherein an aggregate of the thresholds for the same resource represents 100% of that resource.

28. The storage medium of claim 26, further comprising increasing a previously allocated portion of a resource for a given resource group toward the requested portion when one or more others of the resource groups request a lower amount of that resource.
